(19) United States
(12) Patent Application Publication
(10) Pub. No.: US 2012/0175509 A1
(43) Pub. Date: Jul. 12, 2012

(54) GAMMA CAMERA CALIBRATION METHODS AND SYSTEMS

(75) Inventor: Ira Blevis, Zicron Yaakov, IL (US)

(73) Assignee: General Electric Company, Schenectady, NY (US)

(21) Appl. No.: 13/004,681

(22) Filed: Jan. 11, 2011

(51) Int. Cl. G01D 18/00; G01T 1/20

(52) U.S. Cl. 250/252.1; 250/361 R

(57) ABSTRACT

Calibration techniques for a gamma camera of a medical imaging system are provided. The calibration of a gamma camera includes acquiring data from a patient at a gamma camera over a first interval, processing the received data to determine a pixel energy spectrum for each pixel of the data and a main energy peak location for each pixel based on the pixel energy spectrum, and calibrating the gamma camera based on the main energy peak location. Imaging systems implementing the calibration techniques are also provided.

### BACKGROUND OF THE INVENTION

The subject matter disclosed herein relates to single photon emission computed tomography (SPECT), and more particularly to a technique for detector calibration in cardiac imaging using emission data.

A wide range of imaging techniques are known and currently in use, particularly for medical diagnostic applications. One such technique, SPECT, relies on the emission of gamma rays during the radioactive decay of a radioisotope (or radionuclide), commonly administered in the form of a radiopharmaceutical agent that can be carried, and in some cases, bound to particular tissues of interest. A SPECT scanner detects the emissions via a gamma camera that typically includes a collimator, a scintillator, and a series of photomultiplier tubes. The collimator allows only emissions in a particular direction to enter into the scintillator. The scintillator converts the gamma radiation into lower energy ultraviolet photons that impact regions (pixels) of the photomultiplier tubes. These, in turn, generate image data related to the quantity of radiation impacting the individual regions. Image reconstruction techniques, such as backprojection, may then be used to construct images of internal structures of the subject based upon this image data.

While such systems have proven extremely useful at providing high quality images with good diagnostic value, further refinement is needed. For example, SPECT imaging systems may require frequent and costly recalibration of the gamma cameras to maintain image quality and performance of the image system. Such recalibration further results in system downtime and may require special procedures and equipment.

### BRIEF DESCRIPTION OF THE INVENTION

A method is provided that includes accumulating data from a gamma camera of an imaging system, determining an energy spectrum for a pixel of the data, determining an energy peak location of the energy spectrum, determining a difference between a theoretical energy peak location and the energy peak location of the energy spectrum, and calibrating the gamma camera based on the difference.

An imaging system is provided that includes a gamma camera and image processing circuitry coupled to the gamma camera, wherein the image processing circuitry executes code, stored on a non-transitory, tangible machine-readable medium, wherein the code, when executed, accumulates data from the gamma camera, determines an energy spectrum for a pixel of the data, determines an energy peak location of the energy spectrum, determines a difference between a theoretical energy peak location and the energy peak location of the energy spectrum, and calibrates the gamma camera based on the difference.

Another method is provided that includes acquiring data from a patient at a gamma camera over a first interval, processing the acquired data to determine a pixel energy spectrum for each pixel of the data and a main energy peak location for each pixel based on the pixel energy spectrum, and calibrating the gamma camera based on the main energy peak location.

### BRIEF DESCRIPTION OF THE DRAWINGS

These and other features, aspects, and advantages of the present techniques will become better understood when the following detailed description is read with reference to the accompanying drawings in which like characters represent like parts throughout the drawings, wherein:

FIG. 1 is a diagrammatic representation of an exemplary SPECT imaging system incorporating aspects of the present techniques;

FIG. 2 is a flowchart of a calibration process for a gamma camera of a SPECT imaging system in accordance with embodiments of the present techniques; and

FIGS. 3 and 4 are pixel energy spectrums of a gamma camera in accordance with embodiments of the present techniques.

### DETAILED DESCRIPTION OF THE INVENTION

Embodiments of the present disclosure include a calibration technique for gamma cameras of an imaging system. The calibration includes acquiring data from a patient at a gamma camera over a first interval, processing the received data to determine a pixel energy spectrum for each pixel of the data and a main energy peak location for each pixel based on the pixel energy spectrum, and determining a difference between a theoretical energy peak location and the main energy peak location. The pixel energy calibration factors may be corrected based on the difference. Embodiments also include imaging systems implementing the calibration technique.

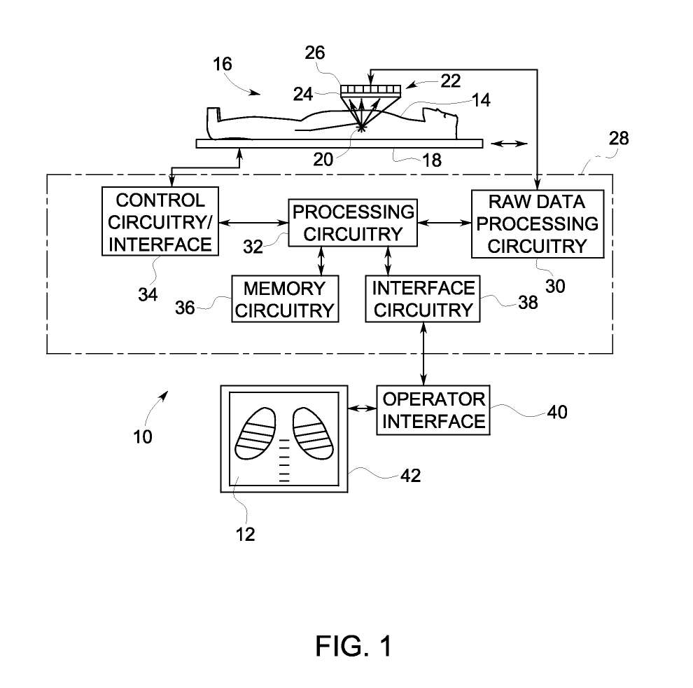

A diagrammatic representation of an exemplary SPECT imaging system is shown in FIG. 1. The system, designated generally by the reference numeral 10, is designed to produce useful images 12 of a subject 14. The subject is positioned in a scanner, designated by reference numeral 16 in which a patient support 18 is positioned. The support may be movable within the scanner to allow for imaging of different tissues or anatomies of interest within subject. Prior to image data collection, a radioisotope, such as a radiopharmaceutical substance (sometimes referred to as a radiotracer), is administered to the patient, and may be bound or taken up by particular tissues or organs. Typical radioisotopes include various radioactive forms of elements, although many in SPECT imaging are based upon an isotope of technetium (⁹⁹Tc) that emits gamma radiation during decay. Various additional substances may be selectively combined with such radioisotopes to target specific areas or tissues of the body. In some embodiments, the imaging system 10 may be an Ultrafast Dedicated Cardiac Camera (UFC) system.

Gamma radiation emitted by the radioisotope is detected by a digital detector or gamma camera 22. Although illustrated in the figure as a planar device positioned above the patient, in practice the camera may be positioned below the patient, both above and below the patient, and/or may wrap completely or partially around the patient. For example, the gamma cameras 22 may be arranged in one or more rings or partial rings around the subject 14, such as 180° around the subject 14, 360° around the subject 14, etc. In general, the gamma camera 22 comprises one or more collimators and a scintillator or a solid state detector, together represented generally as reference numeral 24. In some embodiments, such as the UFC system mentioned above, the gamma camera 22 may include a cadmium zinc telluride (CZT) solid-state detector. The collimator allows gamma radiation emitted only in certain directions (typically perpendicular to the scintillator) to impact the scintillator. The scintillator, which is typically made of a crystalline material, such as sodium iodide (NaI), converts the received gamma radiation to lower energy light energy (e.g., in an ultraviolet range). Photomultiplier tubes 26 then receive this light and generate image data corresponding to photons impacting specific discrete picture element (pixel) regions. In other embodiments, the solid state detector converts the received gamma radiation into electrical signals. In some embodiments, the detector or gamma camera 22 may include one or more “modules.” Each module may be a solid state detection module capable of detecting gamma radiation and producing data for an array of pixels. In some embodiments, a gamma camera may be referred to as including one or more detectors, and each detector may be referred to as including one or more modules.

The gamma camera 22 is coupled to system control and processing circuitry 28. This circuitry may include a number of physical and functional components that cooperate to allow the collection and processing of image data to create the desired images. For example, the circuitry may include raw data processing circuitry 28 that initially receives the data from the gamma camera 22, and that may perform various filtering, value adjustments, and so forth. Processing circuitry 32 allows for the overall control of the imaging system, and for manipulation of image data. The processing circuitry 32 may also perform calibration functions, correction functions, and so forth on the data. The processing circuitry 32 may also perform image reconstruction functions, such as based on certain algorithms (e.g., backprojection or iterative reconstruction). Such functions may also be performed in post-processing on local or remote equipment. The processing circuitry may interact with control circuitry/interface 34 that allows for control of the scanner and its components, including the patient support, camera, and so forth. Moreover, the processing circuitry 32 will be supported by various circuits, e.g., non-transitory tangible machine-readable media such as memory circuitry 36 that may be used to store image data, calibration or correction values, routines performed by the processing circuitry (e.g., as code stored on the memory circuitry 36), and so forth. Finally, the processing circuitry may interact with interface circuitry 38 designed to support an operator interface 40. The operator interface 40 allows for imaging sequences to be commanded, scanner and system settings to be viewed and adjusted, images to be viewed, and so forth. In the illustrated embodiment, the operator interface 40 includes a monitor 42 on which reconstructed images 12 may be viewed.

In certain implementations the processing circuitry 32 and 34 may include specially programmed hardware, memory, or processors (e.g., application-specific integrated circuits (ASICs)) for performing the calibration discussed below. Similarly, all or part of the image reconstruction may be performed using one or more general or special purpose processors and stored code or algorithms configured to execute on such processors. Likewise, a combination of special purpose hardware and/or circuitry may be used in conjunction with one or more processors configured to execute stored code to implement the steps discussed herein. The results of such data processing steps may be displayed on the monitor 42 of the operator interface 40.

In an institutional setting, the imaging system 10 may be coupled to one of more networks to allow for the transfer of system data to and from the imaging system, as well as to permit transmission and storage of image data and processed images. For example, a local area networks, wide area networks, wireless networks, and so forth may allow for storage of image data on radiology department information systems or on hospital information systems. Such network connections further allow for transmission of image data to remote post-processing systems, physician offices, and so forth.

Keeping in mind the SPECT imaging system 10 discussed above, or the corresponding components of other types of suitable imaging systems, a brief description of the functioning of one such system is provided to facilitate further explanation of the present approach. In particular, SPECT imaging is primarily used to measure metabolic activities that occur in tissues and organs and, in particular, to localize aberrant metabolic activity. In SPECT imaging, the patient is typically injected with a solution that contains a radioactive tracer. The solution is distributed and absorbed throughout the body in different degrees, depending on the tracer employed and the functioning of the organs and tissues. In particular, the radioactive tracer emits gamma rays. Sometimes the tracer emits positrons that interact with surrounding particles, thereby generating gamma rays. In a SPECT imaging system 10, the gamma rays are detected by the gamma cameras 22. The gamma rays may be collimated so that the detection of a gamma ray may be used to determine the line of response along which the gamma ray traveled before impacting the detector, allowing localization of the radiotracer source in the organ or tissue of interest. By detecting a number of such gamma rays, and calculating the corresponding lines traveled by the gamma rays, the concentration of the radioactive tracer in different parts of the body may be estimated and a tumor, thereby, may be detected.

In view of these comments, and returning now to FIG. 1, the raw data processing circuitry 28 is adapted to read out signals generated in response to the gamma rays from the photomultiplier tubes 26 of the gamma cameras 22. The signals acquired by the raw data processing circuitry 28 are provided to the processing circuitry 32. The image reconstruction and processing circuitry generates an image based on the derived gamma ray emission locations. Each set of image data captured by one of, and each position of, the gamma cameras 22 may correspond to a 2-D projection made up of 2-D pixels. A reconstruction algorithm may be applied to the 2-D projections to reconstruct a 3-D image. As described below, such a reconstruction may be based on calculating voxels from pixel data acquired at different respective angular positions with respect to the subject 14. The operator interface 40 is utilized by a system operator to provide control instructions to some or all of the described components and for configuring the various operating parameters that aid in data acquisition and image generation. The monitor 42 may also display the generated image.

The detectors or gamma cameras 22 may require calibrations to produce a uniform and sensitive response over the field of the view of the subject 14. The gamma camera 22 may be calibrated according to three different calibrations: linearity calibration, energy calibration, and sensitivity calibration. An energy calibrated gamma camera maximizes the signal to noise response for fluctuations in the source field. During operation, the initial calibration of the gamma camera 22 may not provide adequate performance due to aging and environmental factors. As described below, embodiments of the present disclosure provide a continuous energy calibration technique based on accumulations of patient data over time. As described below, this continuous calibration of the gamma cameras may preserve the highest “lesion detectability” and reduce or eliminate extra calibration procedures. Further, the use of CZT gamma cameras may eliminate the need for linearity calibrations and, together with the continuous energy calibration, may provide a stable sensitivity calibration.

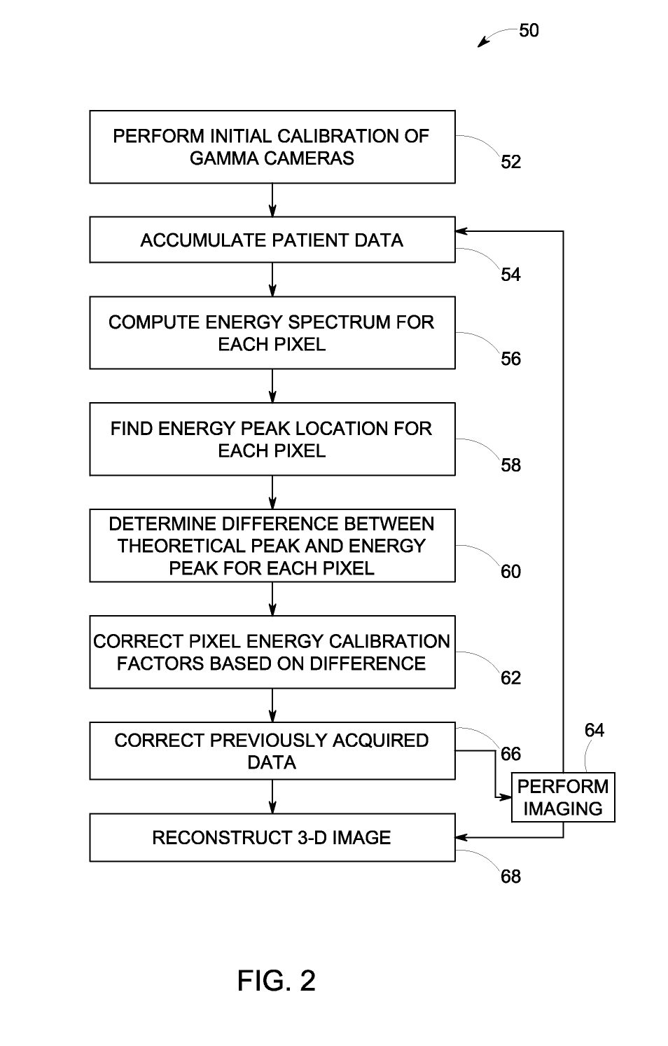

With the foregoing in mind, FIG. 2 depicts a process 50 for continuously calibrating a gamma camera in accordance with an embodiment of the present disclosure. In an embodiment, some of the steps of the process 50 may be implemented as code stored on a non-transitory tangible machine-readable medium, e.g., memory circuitry 36. In some embodiments, the continuous calibration process 50 may performed using CZT gamma cameras of an imaging system.

In some embodiments, the gamma cameras 22 may undergo an initial calibration (block 52). For example, the initial calibration may be performed by the manufacturer of the gamma camera 22 at a manufacturing facility, or the initial calibration may be performed after assemblage of the imaging system 10 but before clinical use of the gamma cameras 22 for data acquisition. In other embodiments, the gamma cameras 22 may not undergo an initial calibration before use in the continuous calibration process.

Next, the gamma cameras 22 may be used to accumulate patient from the subject 14 (block 54). As described above, such data is in pixel data received from the photomultiplier tubes 26 and raw processing circuitry 28. The accumulated data for calibration may be accumulated over any desired time period, such as 1 day, 2 days, 3 days, 4 days, 5 days, 6 days, 1 week, or greater than 1 week. In other embodiments, the accumulated data for calibration may be accumulated based on the number of acquisitions, the number of patients, and/ or total number of counts instead of a time period. For example, the accumulated data may be accumulated over 1, 2, 3, 4, 5, 6, 7, 8, 9, 10 or more than 10 patients. In other embodiments, the data may be accumulated over 1, 2, 3, 4, 5, 6, 7, 8, 9, 10 or more than 10 megacounts.

After accumulating the patient data, the energy spectrum (for each pixel may be computed (block 56). As described below, the energy spectrum may include a main energy peak corresponding to gamma rays received from the region of interest and a “tail” corresponding to scattered gamma rays outside of the primary energy window. Once the energy spectrum is computed, the main energy peak location for each pixel is determined (block 58).

After finding the main energy peak for each pixel, the difference between the theoretical energy peak location and the main energy peak location for each pixel is determined (block 60). The theoretical energy peak location may be based on a theoretical energy spectrum provided for the gamma camera 22. After determining the difference between the theoretical energy peak location and the main energy peak location, the pixel energy calibration factors may be corrected based on the difference or the ratio between theoretical energy peak location and the main energy peak location (block 62). The correction factors may be used to correct calibration factors that shift or rescale the patient data. Alternatively they may be used to correct energy window limits to match the found energy peak locations. After calibration of the gamma camera 22, imaging may be performed using the imaging system (block 64). The imaging may provide for the accumulation of new patient data (block 54), enabling the continuous calibration process to continue with new accumulated patient data. In some embodiments, the corrected energy pixel calibration factors may be used to correct previously acquired patent data (block 66) including the patient data used to find the calibration factors. After acquiring new data or correcting previously acquired data, a 3-D image may be reconstructed (block 68).

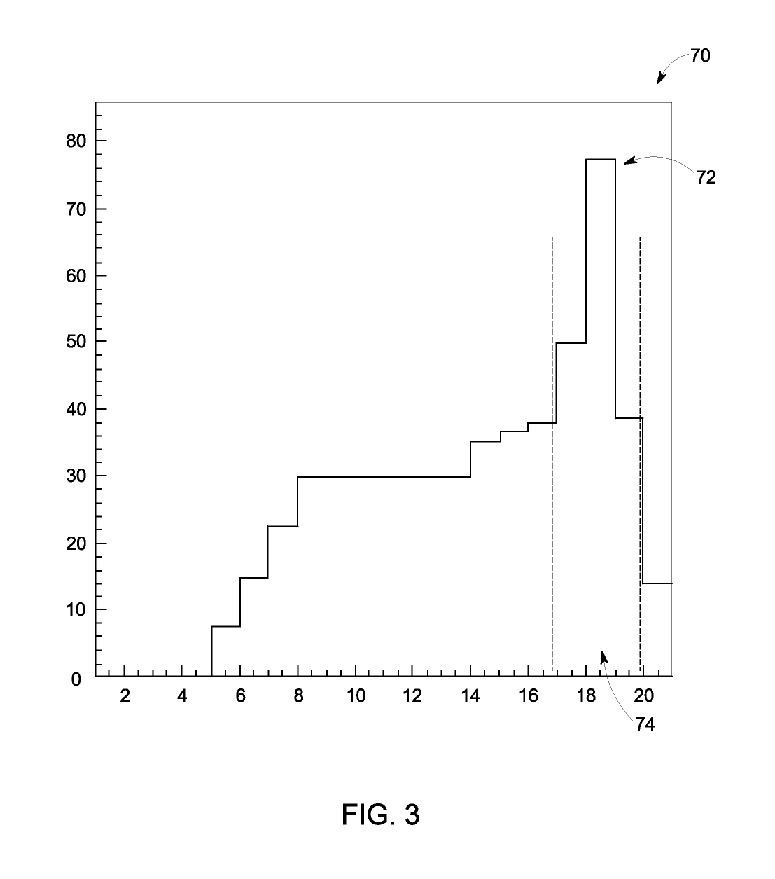

As mentioned above, the continuous calibration techniques disclosed herein may rely on the determined difference between a theoretical energy peak location and a measured energy peak location of an energy spectrum of the gamma camera 22. FIG. 3 depicts an example of an energy spectrum 70 of a CZT gamma camera. As shown in FIG. 3, the energy spectrum 70 may include a main energy peak 72, while the remainder of the energy spectrum may correspond to scattered gamma radiation scattered by the patient and/or the environment before detection at the gamma camera. The main energy peak 72 may be located in an energy window 74.

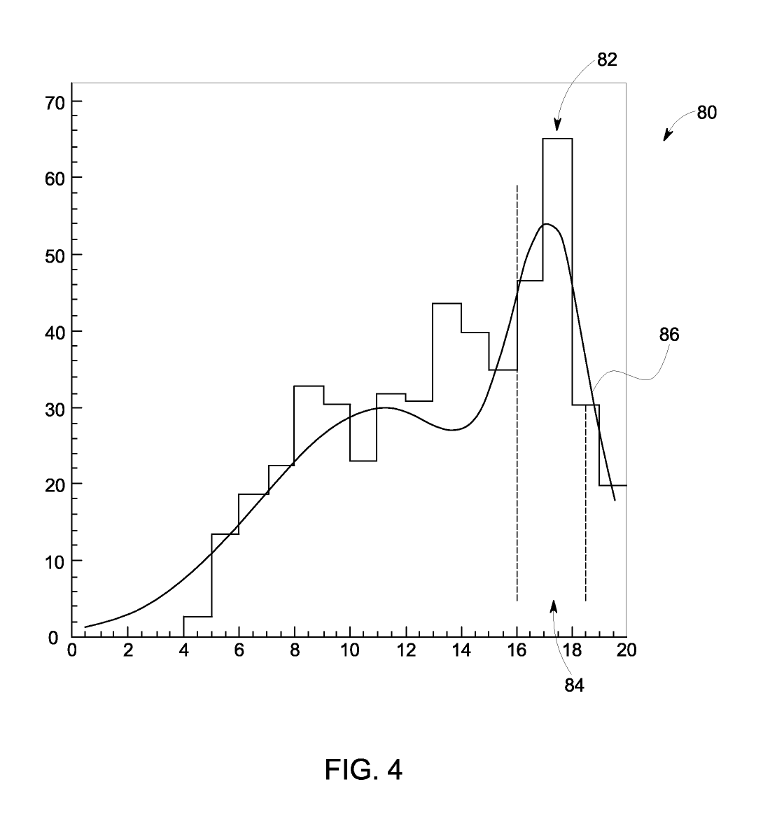

FIG. 4 depicts an energy spectrum 80 of a pixel of a CZT gamma camera after some acquisitions of patient data in accordance with embodiments of the present technique. The difference between a theoretical energy peak and the energy peak 82 may be used to calibrate the gamma camera. In one embodiment, the energy peak 82 may be found by determining the peak in an energy window 84. In another embodiment, as also shown in FIG. 4, the energy peak may be found by fitting a curve 86 to the energy spectrum and determining the peak location of the curve 86.

As noted above, the use of CZT gamma cameras in the imaging system 10 may provide for implementation of the continuous calibration technique described above. The CZT gamma camera may eliminate linearity calibrations and the energy resolution of such cameras may provide for rapid and easy determination of the main energy peak for each pixel even with patient scatter. Further, the elimination of linearity calibration and the continuous energy calibration described may provide for a stable sensitivity calibration of the CZT gamma cameras.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A method, comprising
accumulating data from a gamma camera of an imaging system;
determining an energy spectrum for a pixel of the data;
determining an energy peak location of the energy spectrum;
determining a difference between a theoretical energy peak location and the energy peak location of the energy spectrum; and
calibrating the gamma camera based on the difference.

2. The method of claim 1, wherein calibrating the gamma camera comprises correcting an energy calibration factor for the pixel.

3. The method of claim 1, wherein the gamma camera comprises a cadmium zinc telluride (CZT) solid-state detector.

4. The method of claim 1, wherein determining an energy peak location of the energy spectrum comprising fitting a curve to the energy spectrum.

5. The method of claim 1, wherein determining an energy peak location of the energy spectrum comprising determining an energy window of the energy spectrum.

6. The method of claim 1, comprising accumulating data from the gamma camera over at least 1, 2, 3, 4, 5, 6, or 7 days, over at least 1, 2, 3, 4, 5, 6, 7, 8, 9, or 10 patients, or over at least 1, 2, 3, 4, 5, 6, 7, 8, 9, or 10 megacounts.

7. The method of claim 1, comprising correcting the data based on the calibration of the gamma camera.

8. The method of claim 1, comprising reconstructing a three-dimensional image from the data.

9. An imaging system, comprising:
a gamma camera;
image processing circuitry coupled to the gamma camera, wherein the image processing circuitry executes code, stored on a non-transitory, tangible machine-readable medium, wherein the code, when executed, performs the following:
accumulates data from the gamma camera;
determines an energy spectrum for a pixel of the data;
determines an energy peak location of the energy spectrum;
determines a difference between a theoretical energy peak location and the energy peak location of the energy spectrum; and
calibrates the gamma camera based on the difference.

10. The system of claim 9, wherein the gamma camera comprises a cadmium zinc telluride (CZT) solid-state detector.

11. The system of claim 9, wherein the code, when executed, calibrates the gamma camera by correcting an energy calibration factor for the pixel.

12. The imaging system of claim 9, wherein the data is stored on the image processing circuitry.

13. The system of claim 9, wherein the code, when executed, determines the energy peak location of the energy spectrum comprising fitting a curve to the energy spectrum.

14. The system of claim 9, wherein the code, when executed, determines the energy peak location of the energy spectrum comprising determining an energy window of the energy spectrum.

15. The system of claim 9, wherein the code, when executed, reconstructs a three-dimensional image from the voxel values.

16. A method, comprising:
acquiring data from a patient at a gamma camera over a first interval;
processing the acquired data to determine a pixel energy spectrum for each pixel of the data and a main energy peak location for each pixel based on the pixel energy spectrum; and
calibrating the gamma camera based on the main energy peak location.

17. The method of claim 16, wherein the first interval comprises a period of time comprising at least 1 day, 2 days, 3 days, 4 days, 5 days, 6 days, or 7 days.

18. The method of claim 16, wherein the first interval comprises a number of acquisitions of data from the patient.

19. The method of claim 16, wherein processing the received data comprises determining a difference between the main energy peak location and a theoretical energy peak location.

20. The method of claim 16, wherein the gamma camera comprises a cadmium zinc telluride (CZT) solid-state detector.
